(19) United States
(12) Patent Application Publication
(10) Pub. No.: US 2005/0206912 A1
(43) Pub. Date: Sep. 22, 2005

(54) Image processing apparatus

(75) Inventor: Shunichi Megawa, Tagata-gun (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/805,281

(22) Filed: Mar. 22, 2004

(51) Int. Cl. G06F 15/00

(52) U.S. Cl. 358/1.1

(57) ABSTRACT

A feature amount calculating unit calculates feature amounts of an image on the basis of input image information provided from an image reading apparatus. An image mode deciding unit decides image mode of output image information provided from the apparatus on the basis of the feature amounts provided from the feature amount calculating unit. A reading mode setting unit sets a reading mode of the image reading apparatus on the basis of the image mode decided by the image mode deciding unit.

### BACKGROUND OF THE INVENTION

The present invention relates to an image processing apparatus and an image processing method, and in particular, to an image processing apparatus and an image processing method for, when an original is input as image data by a scanner or the like, easily and appropriately setting various settings of the scanner.

When an image is read by a conventional scanner device, resolution, color mode, and the like are designated from a driver for the scanner in a personal computer or a control panel on the scanner body, and image data is generated by reading an original in accordance therewith. Further, as a technique disclosed in Jpn. Pat. Appln. KOKAI Publication No. 2002-354212, an original having a dedicated mark sheet or a bar code thereon, or an OCR sheet is read as a first sheet of a plurality of pages, and scanner reading mode is set to the remaining sheets as actual texts on the basis of the mark sheet and bar code or the character information of the OCR sheet.

Further, in accordance with a technique disclosed in Jpn. Pat. Appln. KOKAI Publication No. 2003-87562, it is possible to extract and distinguish a region having an attribute of a character or a photograph from multivalued image data such as color or gray scale.

In Jpn. Pat. Appln. KOKAI Publication No. 2002-354212, the reading mode of the originals of on and after the second page is set by reading an original having a dedicated mark sheet or a bar code thereon, or an OCR sheet, as the first page. In this case, it is necessary for a user to select reading mode which seem to be optimum in accordance with the type of the original, and to select a mark sheet or a bar code which corresponds to the reading mode. When the number of patterns of reading modes is large, it can be considered that the selection of a mark sheet or a bar code takes much time for the user, and further, it is difficult to select the optimum reading mode. Further, as disclosed in Jpn. Pat. Appln. KOKAI Publication No. 2003-87562, there has been the technique in which a region having an attribute of a character, a photograph, or the like is extracted and distinguished from multivalued image data such as color or gray scale. However, there has been no technique in which a type of an original is determined by using the technique, and a setting of a scanner is changed.

### BRIEF SUMMARY OF THE INVENTION

An object of the present invention is to reduce a time when a user carries out mode settings of a scanner in consideration of the types of originals, and to output an image signal at the optimum image mode from the input image signal.

In the present invention, by calculating an image feature amounts in a scanner/MFP body, a scanner controller, or a client PC, without using a mark sheet or a bar code, an image signal for which a user wishes is outputted by setting reading mode of the scanner to optimum with respect to an original to be input, or by changing an image after being input by scanning so as to be optimum.

In order to achieve the above object, according to one aspect of the present invention, there is provided an image processing apparatus for processing input image information obtained from an image reading apparatus, and providing output image information, comprising: a stores unit which stores the input image information therein; a feature amount calculating unit which calculates feature amounts of an image on the basis of the input image information; an image mode deciding unit which decides an image mode of the output image information on the basis of the feature amount provided from the feature amount calculating unit; and an image converting unit which converts the input image stored in the storing unit on the basis of the image mode decided by the image mode deciding unit, and outputs the converted image.

### BRIEF DESCRIPTION OF THE SEVERAL VIEWS OF THE DRAWING

FIG. 1 is a block diagram schematically showing a configuration of a control system of an image forming apparatus to which the present invention is applied.

FIG. 2 illustrates a configuration of an image processing apparatus according to a first embodiment of the present invention.

FIG. 3 illustrates a configuration of the image processing apparatus according to the first embodiment of the present invention, and input/output data thereof.

FIG. 4 illustrates a configuration example of an image feature amount calculating unit.

FIG. 5 illustrates one example of input/output image information of a layout analyzing unit.

FIG. 6 illustrates decision examples of an image mode deciding unit.

FIG. 7 illustrates a configuration example of an image processing apparatus to which the present invention is applied.

FIG. 8 illustrates a configuration example of an image processing apparatus according to a second embodiment of the present invention.

FIG. 9 is a flowchart showing an operational example of the image processing apparatus according to the second embodiment shown in FIG. 8.

FIG. 10 illustrates a configuration example of an image processing apparatus according to a third embodiment of the present invention.

FIG. 11 illustrates decision examples for each mode setting data by the image mode deciding unit.

FIG. 12 illustrates a configuration example of an image processing apparatus according to a sixth embodiment of the present invention.

FIG. 13 is a flowchart showing one example of the operations example of the image processing apparatus according to the sixth embodiment shown in FIG. 12.

### DETAILED DESCRIPTION OF THE INVENTION

Hereinafter, embodiments of the present invention will be described with reference to the drawings.

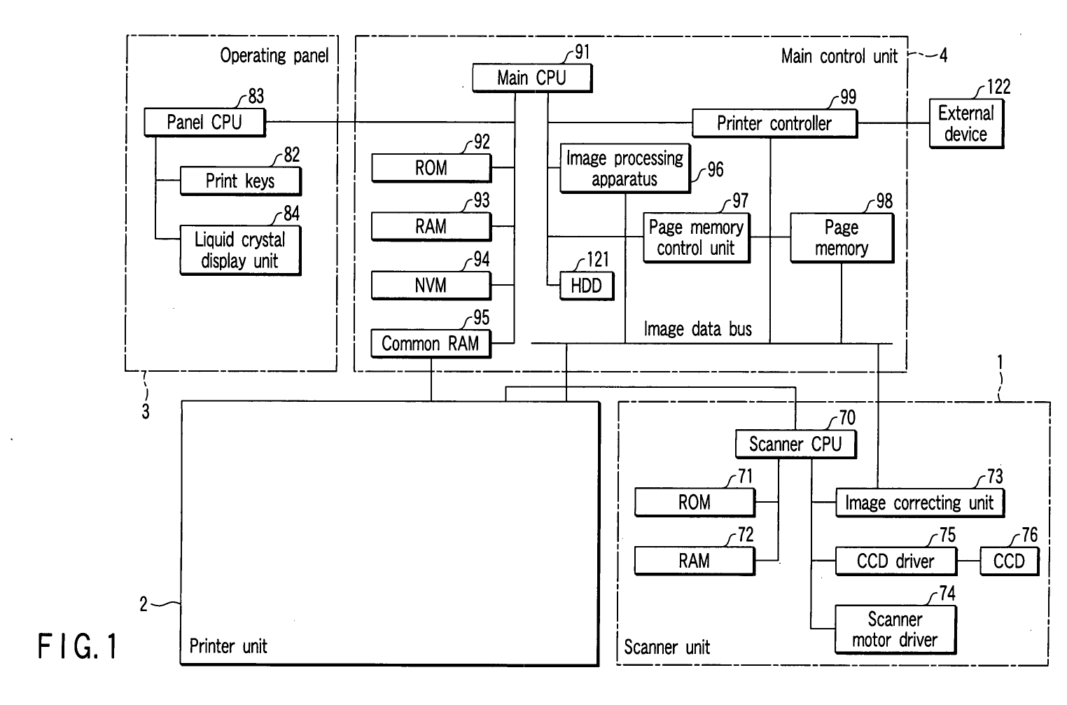

FIG. 1 is a block diagram schematically showing a configuration of a control system of an image forming apparatus to which the present invention is applied.

The image forming apparatus 1 includes a scanner unit 1 which reads an original image and provides image data corresponding to the original image, a printer unit 2 for forming an image on a paper on the basis of the image data from the scanner unit 1, an operating panel 3 for implementing a user interface, and a main control unit 4 for controlling overall the respective units of the image forming apparatus on the basis of a user instruction input via the operating panel 3.

The main control unit 4 is composed of a main CPU 91, a ROM 92, a RAM 93, a nonvolatile memory (NVM) 94, a common RAM 95, an image processing unit 96, a page memory control unit 97, a page memory 98, a hard disk drive (HDD) 121, and the like.

In the ROM 92, various control programs including a control program in accordance with the present invention are stored. The main CPU 91 uses the RAM 93 as a working area, and controls overall the image forming apparatus in accordance with the control program stored in the ROM 92. The main CPU 91 transmits an operating instruction to the printer 2 and the scanner 1, and the printer 2 and the scanner 1 return the statuses to the main CPU 91.

The NVM 94 is a nonvolatile memory which is backed up by a battery (not shown), and maintains data on the NVM 94 at the time of turning a power source off. Further, the NVM 94 stores the default values (initial setting values) with respect to respective hardware factors configuring the image forming apparatus. The common RAM 95 is used for carrying out two-way communication between the main CPU 91 and the printer 2.

The image processing unit 96 carries out image processings such as screen processing, trimming, or masking, and decision of the image mode and calculation of image feature amounts in accordance with the present invention which will be described later, with respect to image data input from the scanner unit 1 or the like.

The printer controller 99 receives code data such as character codes via a LAN from an external device 122 such as a personal computer. The printer controller 99 generates image data from the code data at a size and a resolution which correspond to the data showing a character size and a resolution which is provided to the code data, and stores the image data in the page memory 98.

The page memory control unit 97 controls storing and reading of the image data with respect to the page memory 98. The page memory 98 has a region at which, for example, image data of two pages can be stored, and is configured such that the data in which the image data from the scanner unit 1 or the printer controller 99 is compressed can be stored for each page. The HDD 121 is used, for example, in a case where it is necessary to store the original image data of a large number of pages.

The scanner unit 1 includes a scanner CPU 70, a ROM 71, a RAM 72, an image correcting unit 73, a scanner motor driver 74, a CCD driver 75, and a CCD 76. The scanner CPU 70 controls overall the scanner unit 1, the ROM 71 stores a control program or the like, and the RAM 72 is used for temporarily storing data. The CCD driver 75 drives the CCD 76, and the scanner motor driver 74 controls the rotations of a motor for driving movable parts, such as a carriage for conveying an exposure lamp, in the scanner unit. The image correcting unit 73 includes a shading correction circuit for correcting the irregularities of an analog-to-digital conversion circuit which converts an analog signal from the CCD 76 into a digital signal and the CCD 76, or variations in a level of an output signal from the CCD 76 due to an ambient temperature change or the like.

Next, an image processing method and an image processing apparatus of the present invention which are applied to the image forming apparatus or the image reading apparatus (scanner) as described above will be described. In the present invention, an original is pre-scanned and the optimum image mode are decided. Reading mode of the scanner is set in accordance with the image mode, and the main scanning is carried out.

### First Embodiment

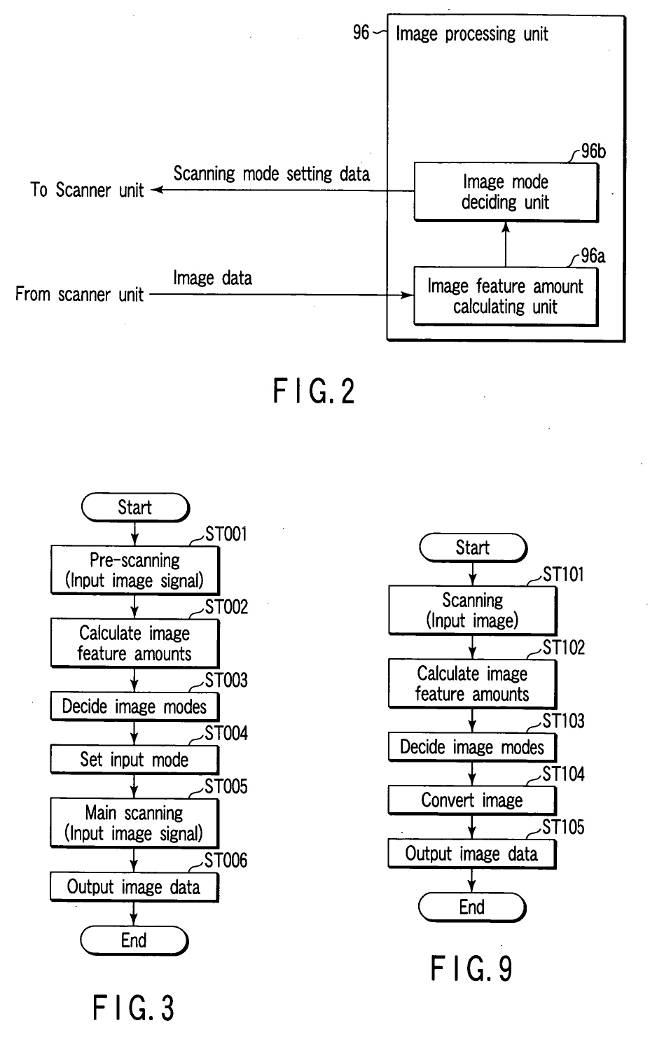

FIG. 2 is a diagram showing a configuration of an image processing unit 96 according to a first embodiment of the present invention, and input/output data thereof.

An image feature amount calculating unit 96a calculates the feature amounts of an image. As the feature amounts, the gross area of character regions, the gross area of photographic regions, an average value of character sizes, the number of color pixels, a luminance maximum value, a luminance minimum value, the area of an original, the total number of pixels, and the like are calculated. An image mode deciding unit 96b decides the image mode on the basis of the image feature amounts output by the image feature amount calculating unit 96a. The image mode to be decided includes a resolution, the number of colors, the number of bits, a density value, and the like.

FIG. 3 is a flowchart showing one example of the processing operations in accordance with the first embodiment.

First, an image of a document is pre-scanned by the scanner unit 1 (step ST001). A reading resolution at that time is set to a relatively low value.

The image feature amount calculating unit 96a calculates the feature amounts such as, the gross area of character regions, the gross area of photographic regions, an average value of character sizes, the number of color pixels, a luminance maximum value, a luminance minimum value, a luminance average value, the area of the original, the total number of pixels of the original, and the like, from the image data output from the scanner unit 1 (ST002).

In the image mode deciding unit 96b, an image mode including information such as resolution, number of colors, color depth (the number of bits of the image data), and density value is decided by using the image feature amounts output from the above-described image feature amount calculating unit 96a (step ST003).

An input mode for the scanner unit 1 is set in accordance with the result decided by the above-described image mode deciding unit 96b (step ST004), the main scanning is carried out (step ST005). Lastly, an image obtained by the scanner unit 1 is output. As a device to be output, there are the printer unit 2, a client PC, an image server, and the like (step ST006).

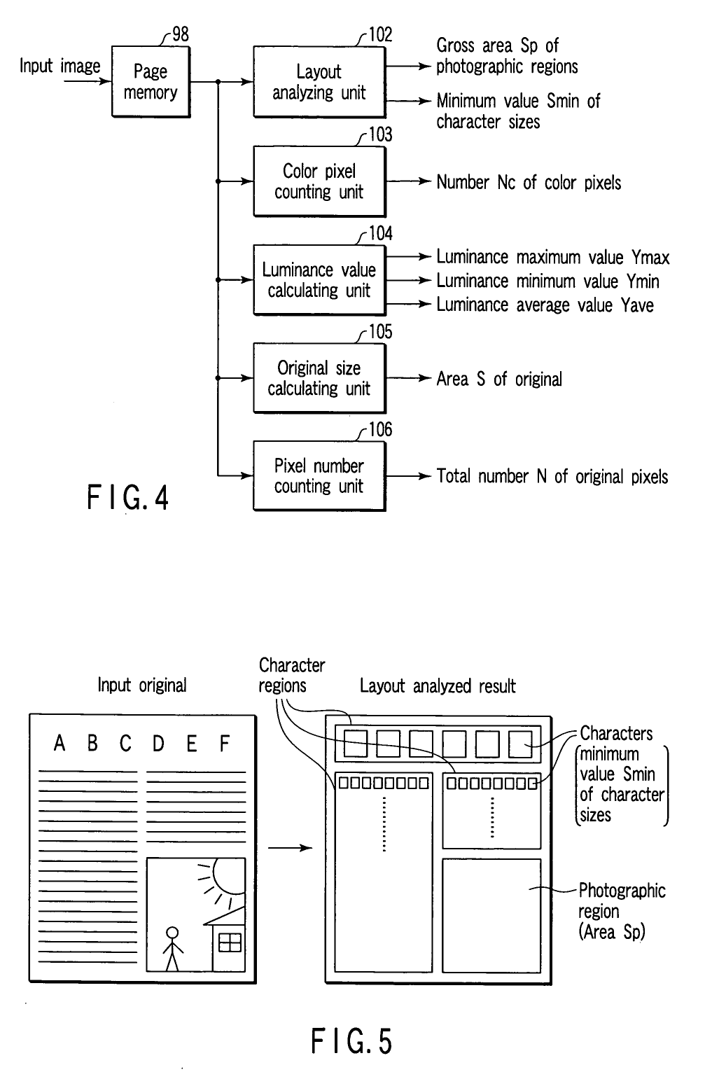

FIG. 4 illustrates a configuration example of the image feature amount calculating unit 96a. In FIG. 4, reference numeral 98 is a page memory, 102 is a layout analyzing unit, 103 is a color pixel counting unit, 104 is a luminance value calculating unit, 105 is an original size computing unit, and 106 is a pixel number counting unit. The page memory 98 converts an image signal input in one line unit or units of several lines into block data in units of pages. As shown in FIG. 5, the layout analyzing unit 102 extracts respective regions such as character regions or graphic regions which are physically or logically made to link together from the original image, distinguishes the document factors of characters, photographs, and the like, and divides the original image in accordance with those regions. The layout analysis may be achieved by using, as a concrete technique, a technique disclosed in Jpn. Pat. Appln. KOKAI Publication No. 2003-87562. The layout analyzing unit 102 outputs positional data of the respective regions and the gross area of photographic regions Sp, and a minimum value of character sizes Smin. The color pixel counting unit 103 determines that pixels satisfying |R−G|+|G−B|+|B−R|>Th (Th is a threshold value) among the image signals of the respective pixels expressed by (R, G, B) are color pixels, and counts the number of color pixels in a page. The luminance value calculating unit 104 converts the RGB image signals into luminance values Y by Yuv linear transformation expressed by, for example, the following formula:
Y=(0.299R+0.587G+0.114B)/255

The luminance value calculating unit 104 outputs a luminance maximum value in the page as Ymax, a luminance minimum value in the page as Ymin, and a luminance average value in the page as Yave. The original size computing unit 105 outputs the area of the original S. The pixel number counting unit 106 calculates the number of original pixels N.

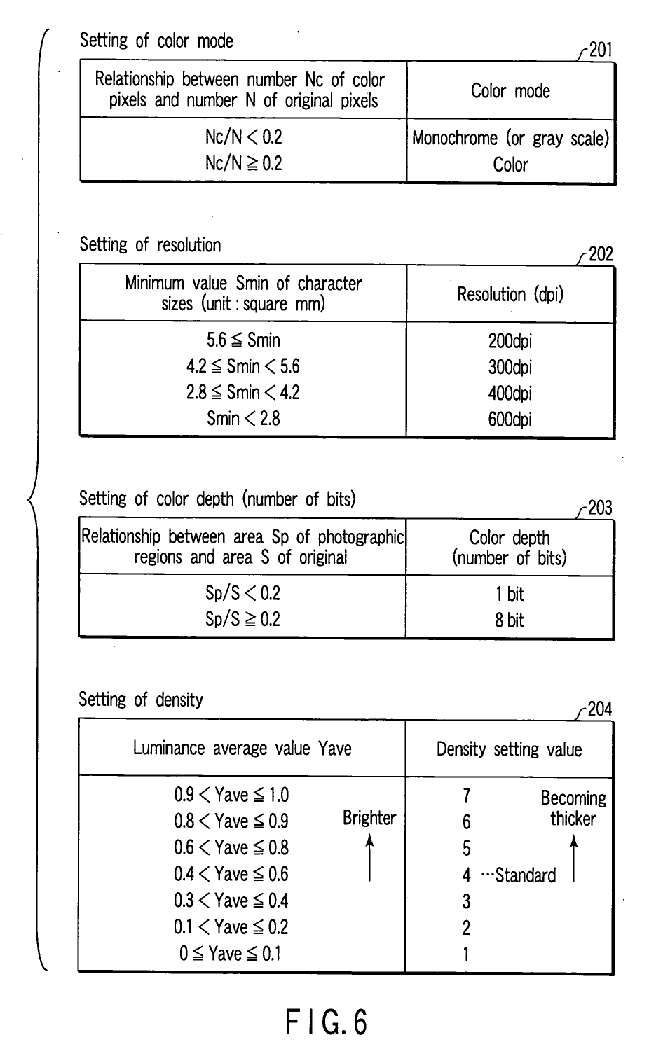

FIG. 6 illustrates the decision examples of the image mode by the image mode deciding unit 96b. Reference numeral 201 shows the setting example of a color mode, 202 shows the setting example of a resolution, 203 shows the setting example of a color depth, and 204 shows the setting example of a density.

The color mode showing whether an original is read in full color or monochrome (or gray scale) is decided in accordance with the relationship between the number of color pixels nc and the number of original pixels N as shown by the table of reference numeral 201. In the present embodiment, when the relationship between the number of color pixels nc and the number of original pixels N is nc/N<0.2, it is determined that the input original is a monochrome original, and the color mode as an image mode is decided to be “monochrome (or gray scale)”. In the case of nc/N>0.2, the color mode is decided to be “color”.

Because the reading resolution of the original is set to a resolution so as to be able to read the minimum sized character in the original, the reading resolution is decided by the minimum value of the character sizes Smin (square mm), for example, as shown in the table 202. In a case of 5.6<S min, the resolution is decided to be 200 dpi; in the case of 4.2<S min<5.6, the resolution is decided to be 300 dpi; in the case of 2.8<S min<4.2, the resolution is decided to be 400 dpi; and in the case of S min<2.8, the resolution is decided to be 600 dpi.

Because the color depth is set by the presence/absence of photographs in the original, the color depth is decided from the relationship between the area of photographic regions Sp and the area of the original S, for example, as shown in the table 203. In the case of Sp/S<0.2, it is determined as the original having characters over the surface thereof, and the color depth is decided to be 1 bit. In the case of Sp/S≧0.2, it is determined that there is a photograph in the original, and the color depth is decided to be 8 bit.

A density is, for example, as shown in the table 204, decided from a luminance average value Yave of the original. In this example, a case is shown in which the standard (default) density setting value of the scanner is “4”. In this example, the greater the setting value is, the thicker the output image becomes. For example, when the density average value Yave of the original image is 0≦Yave≦0.1 (in the case of being darkest), the density setting value is decided to be “1”. In the same way, in the case of 0.1≦Y ave≦0.2, the density setting value is decided to be “2”; in the case of 0.2≦Y ave≦0.4, the density setting value is decided to be “3”; in the case of 0.4≦Y ave≦0.6, the density setting value is decided to be “4”; in the case of 0.6≦Y ave≦0.8, the density setting value is decided to be “5”; in the case of 0.8≦Y ave≦0.9, the density setting value is decided to be “6”; and in the case of 0.9≦Y ave≦1.0 (in the case of being brightest), the density setting value is decided to be “7”.

In this way, the reading mode of the scanner (scanning modes) is set in accordance with the image mode decided by the image mode deciding unit, and the main scanning is carried out. In the present embodiment, the image mode correspond to the scanning mode.

In accordance with the present embodiment, it is possible to reduce a time when a user sets the scanning modes in spite of the type of the original, and to read an original by the optimum scanning modes.

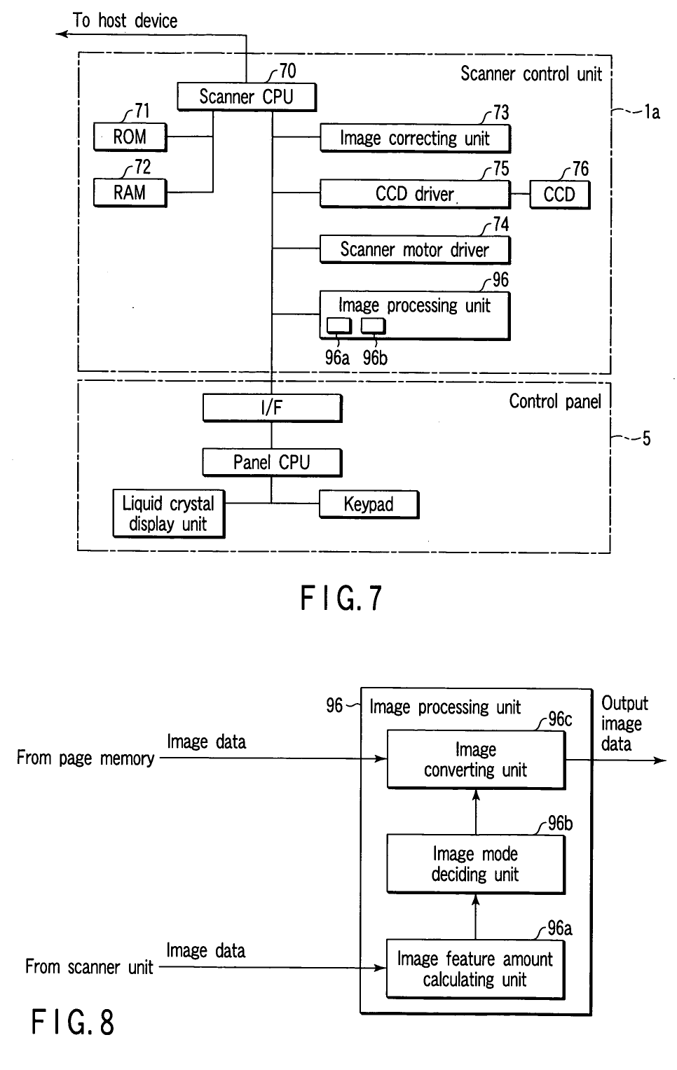

The image processing method in accordance with the present invention can be applied to not only the image forming apparatus as shown in FIG. 1, but also an image reading apparatus (a scanner). FIG. 7 illustrates a configuration example of an image reading apparatus to which the present invention is applied. The image reading apparatus is composed of a scanner control unit 1 and an operating panel 5. Components which are the same as those of FIG. 1 are denoted by the same reference numerals. The image processing unit 96 includes the image feature amount calculating unit 96a and the image mode deciding unit 96b as shown in FIG. 2. Namely, the image processing unit according to the present embodiment can be provided so as to be the configuration of software or hardware, as an image processing apparatus including the image feature amount calculating unit 96a and the image mode deciding unit 96b, in an apparatus such as an image forming apparatus or an image reading apparatus. Image processing apparatuses according to other embodiments which will be shown hereinafter are the same.

### Second Embodiment

FIG. 8 illustrates a configuration example of an image processing apparatus according to a second embodiment of the present invention.

Components which are the same as those of the first embodiment of FIG. 2 are denoted by the same reference numerals, and descriptions thereof will be omitted. In the case of the second embodiment, the image data from the scanner unit 1 obtained by reading the original is provided to the image feature amount calculating unit 96a and is temporarily stored in the page memory 98. The image feature amount calculating unit 96a calculates image feature amounts on the basis of the input image data. The image mode deciding unit 96b decides the image mode on the basis of the image feature amounts. An image converting unit 96c converts the image data stored in the page memory 98 in accordance with the image mode, and the converted image data is provided as the output image data.

FIG. 9 is a flowchart showing one example of the operations of the image processing apparatus according to the second embodiment shown in the above-described FIG. 8.

First, an image on a document is taken in by the scanner unit 1 (step ST101). With respect to the scanning modes at that time, the reading resolution is set to an optical resolution (maximum resolution) of the scanner, and the color mode is set to the full color mode.

The image feature amount calculating unit 96a calculates feature amounts such as, the gross area of character regions, the gross area of photographic regions, an average value of character sizes, the number of color pixels, a luminance maximum value, a luminance minimum value, a luminance average value, the area of the original, the total number of pixels of the original, and the like, from the image data outputted from the scanner unit 1 (ST102).

The image mode deciding unit 96b decides the image mode including information such as a resolution, the number of colors, the number of bits, and a density value by using the image feature amounts output from the above-described image feature amount calculating unit 96a (step ST103).

The image converting unit 96c converts the image data provided from the page memory 98 in accordance with the image mode decided by the above-described the image mode deciding unit 96b (step ST104), and outputs the converted image data. As a device to be output, there are the printer unit 2, a client PC, an image server, and the like (step ST105).

An example of an image conversion by the image converting unit 96c will be described. When a color mode of the original image is decided to be “monochrome” by the image mode deciding unit 96b, for example, it is converted such that G=(R+G+B)/3, and when the color mode is decided to be “color”, the values of RGB are not converted. When the resolution is decided to be a value less than the optical resolution of the scanner, resolution conversion is carried out. As a concrete technique, there is a bicubic method which has been generally known, or the like. When the color depth is decided to be 1 bit, for example, the data conversion is carried out such that R=0 when R≦128, and R=1 when R>128. In the same way, the data conversion is carried out such that G=0 when G≦128, and G=1 when G>128, and the data conversion is carried out such that B=0 when B≦128, and B=1 when B>128. When the color depth is 8 bits, RGB are output the values as are.

With respect to the density setting, when the density decided value is “1”, for example, it is converted such that R′=R×10, G′=G×10, and B′=B×10. However, when the values of R′, G′, and B′ are greater than 255, the values are converted into 255. In the same way, when the density setting value is “2”, it is converted such that R′=R×5, G′=G×5, and B′=B×5; when the density setting value is “3”, it is converted such that R′=R×2.5, G′=G×2.5, and B′=B×2.5; when the density setting value is “5”, it is converted such that R′=R×0.4, G′=G×0.4, and B′=B×0.4; when the density setting value is “6”, it is converted such that R′=R×0.2, G′=G×0.2, and B′=B×0.2; and when the density setting value is “7”, it is converted such that R′=R×0.1, G′=G×0.1, and B′=B×0.1.

In this way, the image converting unit 96c converts the input image data so as to be the image mode decided by the image mode deciding unit 96b. In other words, the image mode deciding unit 96b decides an image mode of the output image data on the basis of the feature amount provided from the feature amount calculating unit 96a.

According to the second embodiment, because it is possible to reduce a time for when the user sets the scanning mode, in spite of the type of an original, and to realize a processing flow of prescanningless, it is possible to output image data at an optimum image mode at a high-speed.

### Third Embodiment

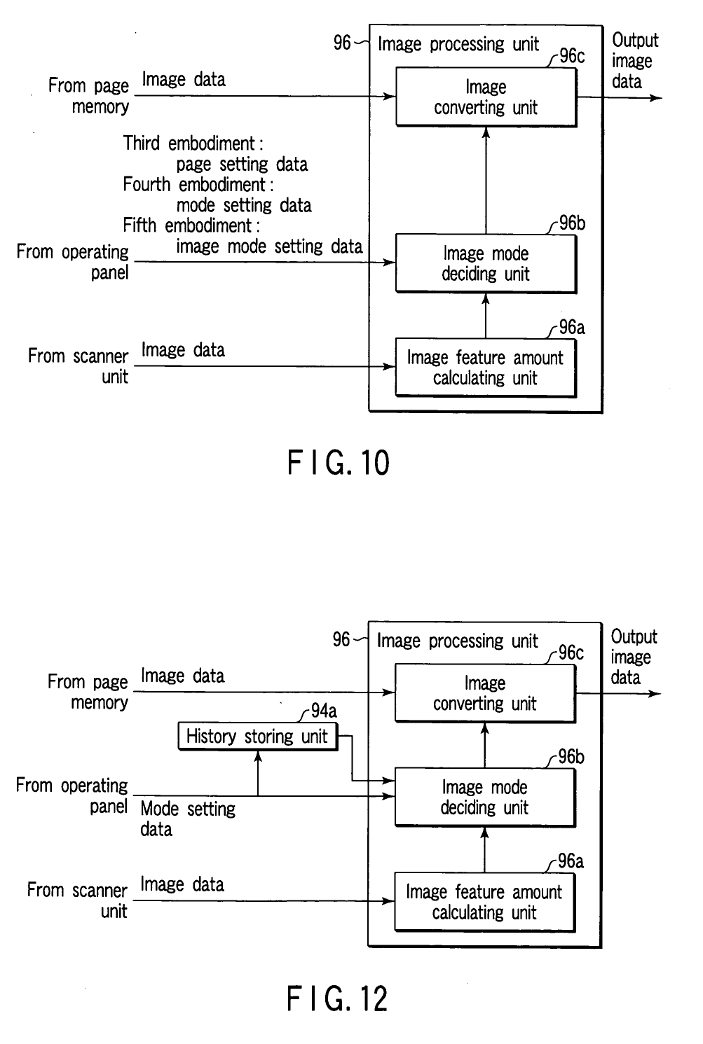

FIG. 10 illustrates a configuration example of an image processing apparatus according to a third embodiment of the present invention.

Components which are the same as those of the second embodiment of FIG. 8 are denoted by the same reference numerals. Although the configuration of the image processing apparatus according to the third embodiment is the same as that of the second embodiment of FIG. 8, page setting data is input to the image mode deciding unit 96b via the operating panel 3 from the user. The page setting data is data showing whether the image mode for all pages is decided to be the same, or the image modes are decided to be optimum for respective pages.

In the same way as in the second embodiment, in the case of the third embodiment as well, the image data from the scanner unit 1 is provided to the image feature amount calculating unit 96a and is temporarily stored in the page memory 98. The image feature amount calculating unit 96a calculates image feature amounts on the basis of the input image data. The image mode deciding unit 96b decides image mode on the basis of the image feature amounts. The image converting unit 96c converts the image data stored in the page memory 98 in accordance with the image mode, and the converted image data is provided as the output image data.

For example, when the user selects “optimum image modes for respective pages” by the operating panel 3, the present image processing apparatus carries out the processings in the way shown in the second embodiment for respective pages, and decides image modes for respective pages. Further, when the user selects “same image mode for all pages” by the operating panel 3, image mode for the all pages is decided by the image mode deciding unit, for example, by using only the image feature amounts of the first page. Or, with being intended for the all pages, a minimum character size, a luminance maximum value, a luminance minimum value, a luminance average value, the gross area of photographic regions, the total number of color pixels, the gross area of the originals, and the total number of pixels of the original are extracted as the feature amounts, and the image mode intended for all pages may be decided. Note that, in the first embodiment shown in FIG. 2, the image mode deciding unit may input such page setting data, and the scanning modes of the scanner unit 1 may be set to the corresponding modes.

In accordance with the present embodiment, in a case of reading plural pages of originals as well, it is possible to reduce a time when the user sets the scanning modes in spite of the type of an original, and to output image data at the optimum image mode.

### Fourth Embodiment

Next, a modified example of the above-described third embodiment will be described as a fourth embodiment of the present invention. A configuration of an image processing apparatus according to the fourth embodiment is the same as in the third embodiment. In the case of the fourth embodiment, as shown in FIG. 10, mode setting data are input to the image mode deciding unit 96b via the operating panel 3 from the user. The mode setting data are data relating to an image reading speed of the scanner unit 1, and a high-speed mode and a high picture quality mode have been prepared.

The image mode deciding unit 96b decides an image mode on the basis of both of the mode setting data input from the operating panel 3 and the image feature amounts input from the image feature amount calculating unit 96a. The page memory 98 temporarily stores the input image signal output from the scanner unit 1. The image converting unit 96c converts the input image data temporarily stored in the page memory 98 and output therefrom, in accordance with the image mode decided by the image mode deciding unit.

FIG. 11 is decision examples for each mode setting data by the image mode deciding unit. In the high-speed mode, as in 301a to 303a, in order to reduce as much information amount as possible from the output image data, the conditions have been set such that it is easy to be that the color mode is monochrome, the resolution is a low resolution, and the color depth is 1 bit. In contrast thereto, in the high picture quality mode, as in 301b to 303b, in order to not reduce information amount from the output image data, the conditions have been set such that it is easy to be that the color mode is color, the resolution is a high resolution, and the color depth is 8 bits.

As the modes in addition thereto, for each usage purpose after storing image data file, the modes, for example, for browsing a screen, for printing, for distributing mails, or the like may be provided.

According to the present embodiment, it is possible to reduce a time when the user sets the scanning modes in spite of the type of an original, and due to the simple inputting by the user, it is possible to output image data at the optimum image mode which more suits the taste of the user.

### Fifth Embodiment

Next, another modified example of the above-described third embodiment will be described as a fifth embodiment of the present invention. A configuration of an image processing apparatus according to the fifth embodiment is the same as those of the third embodiment. In the case of the fifth embodiment, as shown in FIG. 10, the image mode setting data are inputted to the image mode deciding unit 96b via the operating panel 3 from the user. The image mode setting data are data for setting one item or a plurality of items among image mode items of the color mode, the resolution, the color depth, and the density.

The image mode deciding unit 96b sets the image mode items other than the items inputted from the operating panel 3 on the basis of the image feature amounts output from the image feature amount calculating unit 96a. The image data from the scanner unit 1 is temporarily stored by the page memory 98. The image converting unit 96c converts the image in accordance with the image data temporarily stored in the page memory 98 and output therefrom, and the image mode decided by the image mode deciding unit.

According to the present embodiment, it is possible to reduce a time when the user sets the scanning modes in spite of the type of an original, and due to the simple inputting by the user, it is possible to output image data at optimum image mode which more suits the taste of the user.

### Sixth Embodiment

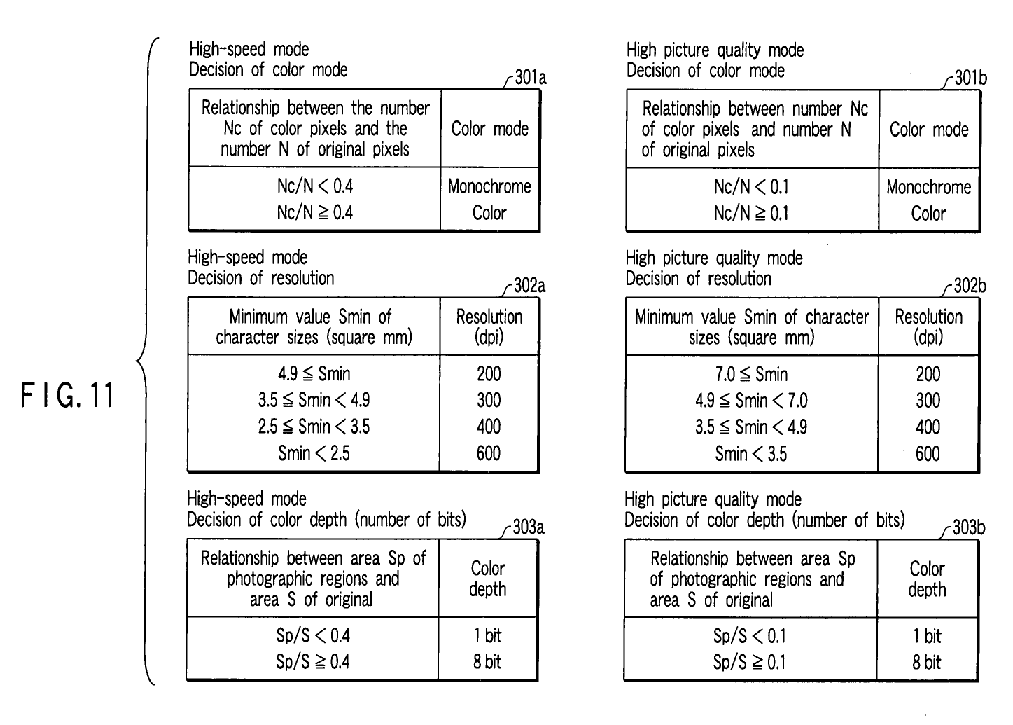

FIG. 12 illustrates a configuration example of an image processing apparatus according to a sixth embodiment of the present invention. In the image processing apparatus according to the sixth embodiment, in addition to the image feature amount calculating unit 96a, the image mode deciding unit 96b, and the image converting unit 96c which are described in the above embodiments, a history storing unit 94a is provided.

In the case of the sixth embodiment as well, the image mode setting data are input to the image mode deciding unit 96b via the operating panel 3 from the user. The history storing unit 94a stores the image feature amounts calculated by the image feature amount calculating unit 96a, and the image mode setting data input from the user in accordance with the input image data, when the original image data is input from the scanner unit 1. The history storing unit 94a can be configured by using a nonvolatile memory, for example, such as the NVM 94. Note that data showing whether or not the history data stored in the history storing unit 94a is used is further input from the operating panel 3, and the image mode deciding unit 96b may be set in accordance with the data.

The image mode deciding unit 96b decides the image mode items other than the input items on the basis of the image feature amounts calculated by the image feature amount calculating unit, when any of the image mode items has been input via the operating panel 3 from the user. In the other cases, the image mode deciding unit 96b decides image mode on the basis of the image feature amounts and the history information.

The page memory 98 temporarily stores the image data from the scanner unit 1. The image converting unit 96c converts the image data temporarily stored in the page memory 98 and output therefrom, in accordance with the image mode decided by the image mode deciding unit.

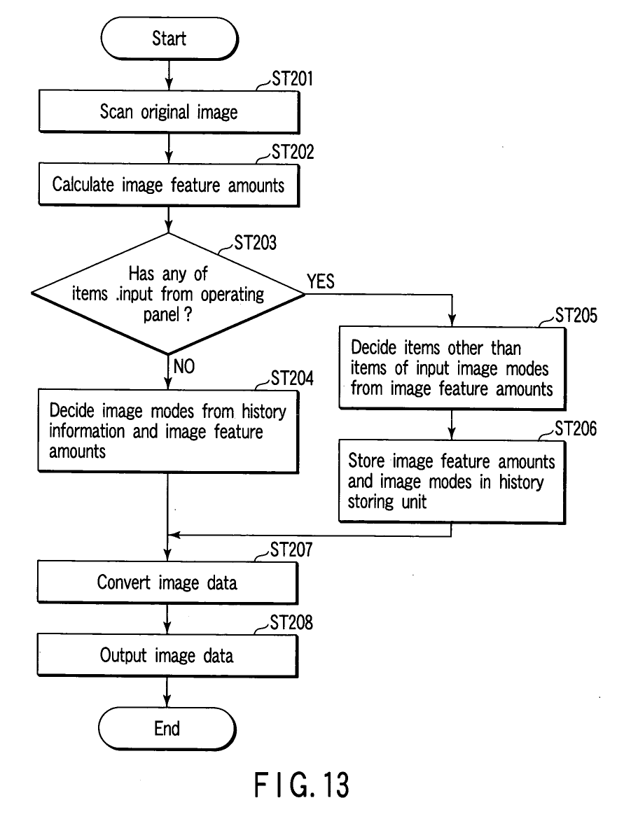

FIG. 13 is a flowchart showing one example of the operations of the image processing apparatus according to the sixth embodiment shown in the above-described FIG. 12.

First, an image on a document is read by the scanner unit 1 (step ST201), and the original image data is stored in the page memory 98. With respect to the scanning modes at that time, the reading resolution is set to an optical resolution of the scanner, and the color mode is set to the full color mode.

The image feature amount calculating unit 96a calculates feature amounts such as, the gross area of character regions, the gross area of photographic regions, an average value of character sizes, the number of color pixels, a luminance maximum value, a luminance minimum value, a luminance average value, the area of the original, the total number of pixels of the original, and the like, from the image data output from the scanner unit 1 (step ST202).

It is determined whether or not any of items relating to the image mode is input from the operating panel 3 by the user (step ST203). When it is input, the image mode deciding unit 96b decides image mode items other than the input items by using the image feature amounts calculated in step ST 202 (step ST205). Further, the image feature amounts calculated in step ST202 and the input image mode are stored in the history storing unit 94a (step ST206). The image converting unit 96c converts and outputs the image stored in the page memory 98 in accordance with the input image mode and the decided image mode (steps ST204 and ST 207).

When no item is input from the operating panel 3 (No in step ST203), the image mode deciding unit 96b decides the image mode from the history information stored in the history storing unit 94a and the image feature amounts calculated in step ST202 (step ST204). The image converting unit 96c converts and outputs image data stored in the page memory 98 in accordance with the image mode decided in step ST204 (steps ST204 and ST207).

In the present embodiment, the example is shown in which, when the user inputs some of the items, the image mode are decided by using only the image feature amounts with respect to the other items. However, with respect to the other items as well, the image mode may be decided by using the image feature amounts and the history information.

In accordance with the present embodiment, by referring to the settings (image mode items) by the user when the image data of the similar original is inputted in the past, it is possible to reduce the time when the user carries out mode settings in consideration of the type of an original, and it is possible to set the input image signal to the image mode which is made to suit the taste of the user.

1. An image processing apparatus for processing input image information obtained from an image reading apparatus, and providing output image information, comprising:
a storing unit which stores the input image information therein;
a feature amount calculating unit which calculates feature amounts of an image on the basis of the input image information;
an image mode deciding unit which decides image mode of the output image information on the basis of the feature amount provided from the feature amount calculating unit; and
an image converting unit which converts the input image stored in the storing unit on the basis of the image mode decided by the image mode deciding unit, and outputs the converted image.

2. An image processing apparatus according to claim 1, further comprising a setting data inputting unit which inputs setting data relating to the image reading apparatus, wherein
the image mode deciding unit decides image mode of the output image information by using the feature amounts provided from the feature amount calculating unit and the setting data provided from the setting data inputting unit.

3. An image processing apparatus according to claim 2, wherein the setting data inputting unit inputs, as the setting data, page setting data for deciding whether same image mode is set for all pages of originals or optimum image modes are set for respective pages of originals.

4. An image processing apparatus according to claim 2, wherein the setting data inputting unit inputs, as the setting data, mode setting data which shows an image reading speed of the image reading apparatus, and includes a high-speed mode setting data and a high picture quality mode setting data.

5. An image processing apparatus according to claim 2, wherein the setting data inputting unit inputs, as the setting data, image mode setting data for setting image mode items.

6. An image processing apparatus according to claim 5, wherein the image mode items have at least one of a color mode, a resolution, a color depth, and a density.

7. An image processing apparatus according to claim 5, wherein the image mode deciding unit decides the image mode of the output image information on the basis of the feature amounts provided from the feature amount calculating unit with respect to the image mode items other than the items to which the image mode setting data are input.

8. An image processing apparatus according to claim 5, further comprising a history storing unit which stores the feature amounts provided from the feature amount calculating unit and the image mode provided from the setting data inputting unit, wherein the image mode deciding unit decides the image mode of the output image information on the basis of the feature amounts provided from the feature amount calculating unit and the history information provided from the history storing unit.

9. An image processing apparatus for processing input image information obtained from an image reading apparatus, and providing output image information, comprising:
a feature amount calculating unit which calculates feature amounts of an image on the basis of the input image information;
an image mode deciding unit which decides an image mode on the basis of the feature amounts provided from the feature amount calculating unit; and
a reading mode setting unit which sets a reading mode of the image reading apparatus on the basis of the image mode decided by the image mode deciding unit.

10. An image processing apparatus according to claim 9, further comprising a setting data inputting unit which inputs setting data relating to the image reading apparatus, wherein
the image mode deciding unit decides the reading mode of the image reading apparatus by using the feature amounts provided from the feature amount calculating unit and the setting data provided from the setting data inputting unit.

11. An image forming apparatus comprising:
an image reading unit which optically reads an original image, and which provides image information corresponding to the original image;
a storing unit which stores the image information provided from the image reading unit therein;
a feature amount calculating unit which calculates feature amounts of an image on the basis of the image information provided from the image reading unit;
an image mode deciding unit which decides an image mode on the basis of the feature amounts provided from the feature amount calculating unit;
an image converting unit which converts the image information stored in the storing unit on the basis of the image mode decided by the image mode deciding unit; and
a printing unit which prints an image on a paper on the basis of the image information converted by the image converting unit.

12. An image forming apparatus according to claim 10, further comprising a reading mode setting unit which sets a reading mode of the image reading unit on the basis of the image mode decided by the image mode deciding unit.

13. An image forming apparatus according to claim 11, further comprising a setting data inputting unit which inputs setting data relating to the image reading unit, wherein
the image mode deciding unit decides image mode of the output image information by using the feature amounts provided from the feature amount calculating unit and the setting data provided from the setting data inputting unit.

14. An image forming apparatus according to claim 11, wherein the setting data inputting unit inputs, as the setting data, page setting data for deciding whether same image mode is set for all pages of originals or optimum image modes are set for respective pages of originals.

15. An image forming apparatus according to claim 13, wherein the setting data inputting unit inputs, as the setting data, mode setting data which shows an image reading speed of the image reading apparatus, and includes a high-speed mode setting data and a high picture quality mode setting data.

16. An image forming apparatus according to claim 12, wherein the setting data inputting unit inputs, as the setting data, image mode setting data for setting image mode items.

17. An image forming apparatus according to claim 16, wherein the image mode items have at least one of a color mode, a resolution, a color depth, and a density.

18. An image processing method for processing input image information obtained from an image reading unit, and providing output image information, comprising:
storing the input image information in a storing unit;
calculating feature amounts of an image on the basis of the input image information;
deciding image mode of the output image information on the basis of the feature amounts; and
converting the input image stored in the stores unit on the basis of the image mode, and outputting the converted image.
